(19) United States
(12) Patent Application Publication
(10) Pub. No.: US 2026/0029698 A1
(43) Pub. Date: Jan. 29, 2026

(54) LIGHT SOURCE APPARATUS, ILLUMINATOR, AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 19/279,332

(22) Filed: Jul. 24, 2025

(30) Foreign Application Priority Data
Jul. 26, 2024 (JP) 2024-120945

(51) Int. Cl. G03B 21/20

(52) U.S. Cl. CPC G03B 21/2013; G03B 21/204; G03B 21/2073

(57) ABSTRACT

A light source apparatus according to an aspect of the present disclosure includes: a first light source configured to output first light; a wavelength converter configured to convert the first light into second light; a second light source configured to output third light; a light guide configured to guide the first light, the second light, and the third light; and a controller configured to control a state in which the second light source outputs the third light. The wavelength converter has a first surface, a second surface, and a third surface. The first light enters the wavelength converter through the third surface via the light guide. The second light travels through the light guide and exits out of a region on the first surface side of the light guide. The third light includes fourth light in a first polarization state, and fifth light in a second polarization state, and enters a region on the second surface side of the light guide. The second light source includes a first light emitting section configured to emit the fourth light and a second light emitting section configured to emit the fifth light. The light emitting sections each include a laser diode. The controller is configured to temporally change a ratio between an amount of the fourth light and an amount of the fifth light.

The present application is based on, and claims priority from JP Application Serial Number 2024-120945, filed Jul. 26, 2024, the disclosure of which is hereby incorporated by reference herein in its entirety.

### BACKGROUND

### 1. Technical Field

The present disclosure relates to a light source apparatus, an illuminator, and a projector.

### 2. Related Art

As a light source apparatus used in a projector, there has been a proposed light source apparatus using fluorescence emitted from a phosphor when the phosphor is irradiated with excitation light output from a light emitter. JP-A-2016-173391 described below discloses an illuminator including a laser light source that outputs excitation light and blue light, a polarization separator that separates the excitation light and the blue light from each other, a fluorescence emitter that converts the excitation light in terms of wavelength into fluorescence, and a diffuser that diffuses the blue light. According to the illuminator, the polarization separator combines the yellow fluorescence emitted from the fluorescence emitter with the blue light output from a diffusive reflector to generate white illumination light.

JP-A-2016-173391 is an example of the related art.

In the illuminator disclosed in JP-A-2016-173391, the blue light component of the white illumination light is derived from the laser light output from the laser light source. However, since laser light is coherent light, in a projector including an illuminator of this type, speckles produced by interference of the laser light are visually recognized on a screen in some cases. There is therefore a problem of deterioration of the display quality. Although the illuminator disclosed in JP-A-2016-173391 includes a fixed diffuser, it is difficult to suppress the speckles only by diffusing the blue light with a diffuser of this type.

### SUMMARY

A light source apparatus according to an aspect of the present disclosure includes: a first light source configured to output first light having a first wavelength band; a wavelength converter configured to convert the first light into second light having a second wavelength band different from the first wavelength band; a second light source configured to output third light having a third wavelength band; a light guide disposed between the first light source and the wavelength converter and configured to guide each of the first light, the second light, and the third light; and a controller configured to control a state in which the second light source outputs the third light. The wavelength converter has a first surface and a second surface that face each other in opposite directions, and a third surface that intersects with the first surface and the second surface. The first light output from the first light source enters the wavelength converter through the third surface via the light guide. The second light travels through the light guide and exits out of a region on the first surface side of the light guide. The third light includes fourth light in a first polarization state, and fifth light in a second polarization state different from the first polarization state, and enters a region on the second surface side of the light guide. The second light source includes a first light emitting section configured to emit the fourth light and a second light emitting section configured to emit the fifth light. The first light emitting section and the second light emitting section each include a laser diode. The controller is configured to temporally change a ratio between an amount of the fourth light emitted from the first light emitting section and an amount of the fifth light emitted from the second light emitting section.

An illuminator according to another aspect of the present disclosure includes: the light source apparatus according to the aspect of the present disclosure; and a polarization converter configured to convert a polarization state of light output from the light source apparatus.

A projector according to another aspect of the present disclosure includes: the light source apparatus according to the aspect of the present disclosure; a light modulator configured to modulate light output from the light source apparatus; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a cross-sectional view of the light source apparatus according to the first embodiment and shows a state in which blue light is emitted in a first period.

FIG. 3 is a cross-sectional view of the light source apparatus according to the first embodiment and shows a state in which the blue light is emitted in a second period.

FIG. 4 is a cross-sectional view of the light source apparatus according to the first embodiment and shows a state in which the blue light is emitted in a third period.

FIG. 5 is a cross-sectional view of the light source apparatus taken along a line V-V in FIG. 2.

FIG. 6 illustrates an effect of a polarization converter.

FIG. 7 is a cross-sectional view of a light source apparatus according to a second embodiment.

FIG. 8 is a cross-sectional view of a light source apparatus according to a third embodiment.

FIG. 9 is a cross-sectional view of a light source apparatus according to a fourth embodiment.

FIG. 10 is a schematic configuration diagram of a projector according to a fifth embodiment.

### DESCRIPTION OF EMBODIMENTS

### First Embodiment

A first embodiment of the present disclosure will be described below with reference to the drawings.

A projector according to the present embodiment is an example of a projector using liquid crystal panels as light modulators.

In the following drawings, elements may be drawn at different dimensional scales for clarity of the elements.

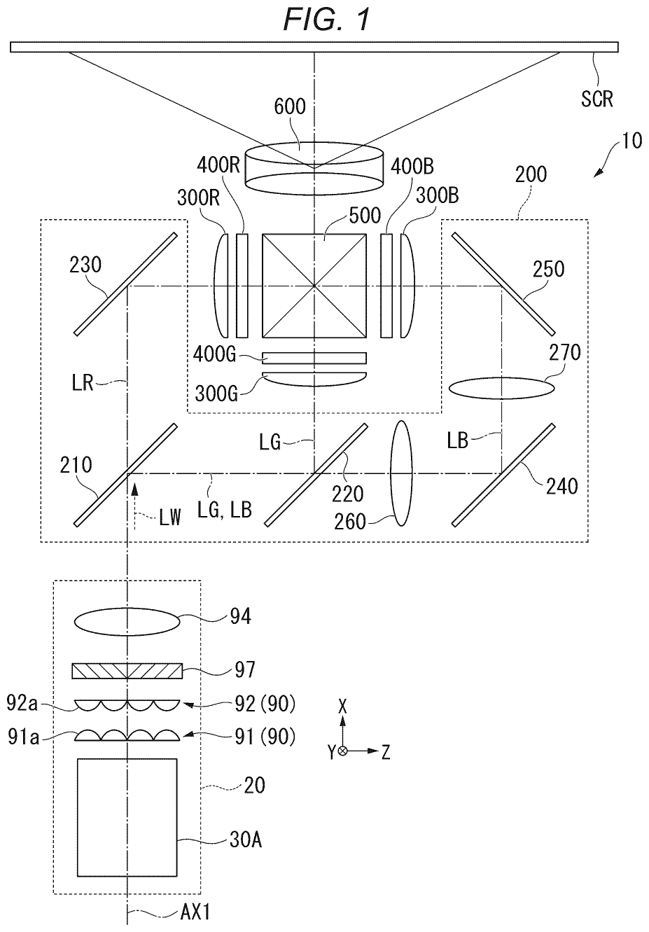

FIG. 1 is a schematic configuration diagram of a projector 10 according to the present embodiment.

The projector 10 according to the present embodiment is a projection-type image display apparatus that displays a color image on a screen SCR, which is a projection receiving surface, as shown in FIG. 1. The projector 10 includes three light modulators corresponding to three types of colored light, red light LR, green light LG, and blue light LB.

The projector 10 includes an illuminator 20, a color separation/light guide system 200, a red light modulator 400R, a green light modulator 400G, a blue light modulator 400B, a light combiner 500, and a projection optical apparatus 600.

The illuminator 20 includes a light source apparatus 30A, optical an integration system 90, a polarization converter 93, and a superimposing system 94. The illuminator 20 outputs white light LW including the red light LR, the green light LG, and the blue light LB. A specific configuration of the illuminator 20 will be described later.

The following description with reference to the drawings will be made by using an XYZ orthogonal coordinate system as required. The X-axis is an axis parallel to an optical axis AX1 of the illuminator 20 and extends along the frontward-rearward direction of the projector 10. The Y-axis is an axis orthogonal to the X-axis and extends along the upward-downward direction of the projector 10. The Z-axis is an axis orthogonal to the X-axis and the Y-axis, and extends along the rightward-leftward direction of the projector 10. The notations described above are intended for describing the positional relationship among the constituent members of the projector 10, and do not limit the posture and the orientation of the installed projector 10. The optical axis AX1 of the illuminator 20 is the center axis of the white light LW output from the illuminator 20.

In the following description, one of the two directions along the X-axis is referred to as a +X direction, and the direction opposite the +X direction is referred to as a −X direction. One of the two directions along the Y-axis is referred to as a +Y direction, and the direction opposite the +Y direction is referred to as a −Y direction. One of the two directions along the Z-axis is referred to as a +Z direction, and the direction opposite the +Z direction is referred to as a −Z direction. When the two directions along the X-axis are not distinguished from each other, they are collectively referred to as an X-axis direction. When the two directions along the Y-axis are not distinguished from each other, they are collectively referred to as a Y-axis direction. When the two directions along the Z-axis are not distinguished from each other, they are collectively referred to as a Z-axis direction.

The color separation/light guide system 200 includes a first dichroic mirror 210, a second dichroic mirror 220, a first reflection mirror 230, a second reflection mirror 240, a third reflection mirror 250, a first relay lens 260, and a second relay lens 270. The color separation/light guide system 200 separates the white light LW output from the illuminator 20 into the red light LR, the green light LG, and the blue light LB, guides the red light LR to the red light modulator 400R, guides the green light LG to the green light modulator 400G, and guides the blue light LB to the blue light modulator 400B.

A field lens 300R is disposed between the color separation/light guide system 200 and the red light modulator 400R. A field lens 300G is disposed between the color separation/light guide system 200 and the green light modulator 400G. A field lens 300B is disposed between the color separation/light guide system 200 and the blue light modulator 400B. The field lens 300R parallelizes the chief ray of the red light LR to be incident on the light modulator 400R. The field lens 300G parallelizes the chief ray of the green light LG to be incident on the green light modulator 400G. The field lens 300B parallelizes the chief ray of the blue light LB to be incident on the blue light modulator 400B.

The first dichroic mirror 210 transmits the red light LR and reflects the green light LG and the blue light LB. The second dichroic mirror 220 reflects the green light LG and transmits the blue light LB. The first reflection mirror 230 reflects the red light LR. The second reflection mirror 240 and the third reflection mirror 250 each reflect the blue light LB.

The red light modulator 400R, the green light modulator 400G, the blue light modulator 400B each modulate the colored light incident on the light modulator in accordance with image information to produce image light. The red light modulator 400R, the green light modulator 400G, the blue light modulator 400B are each configured with a liquid crystal panel.

Although not shown, light-incident-side polarizers are disposed between the field lens 300R and the red light modulator 400R, between the field lens 300G and the green light modulator 400G, and between the field lens 300B and the blue light modulator 400B. Furthermore, light-exiting-side polarizers are disposed between the red light modulator 400R and the light combiner 500, between the green light modulator 400G and the light combiner 500, and between the blue light modulator 400B and the light combiner 500. The light-incident-side polarizers and the light-exiting-side polarizers transmit only linearly polarized light polarized in a specific direction.

When the image light output from the red light modulator 400R, the image light output from the green light modulator 400G, and the image light output from the blue light modulator 400B enter the light combiner 500, the light combiner 500 combines the image light corresponding to the red light LR, the image light corresponding to the green light LG, and the image light corresponding to the blue light LB with one another and outputs the combined image light toward the projection optical apparatus 600. The light combiner 500 is, for example, a cross dichroic prism.

The projection optical apparatus 600 is configured with multiple projection lenses. The projection optical apparatus 600 enlarges the combined image light from the light combiner 500 and projects the enlarged image light toward the screen SCR. An image is thus displayed on the screen SCR.

The configurations of the light source apparatus 30A and the illuminator 20 will be described below.

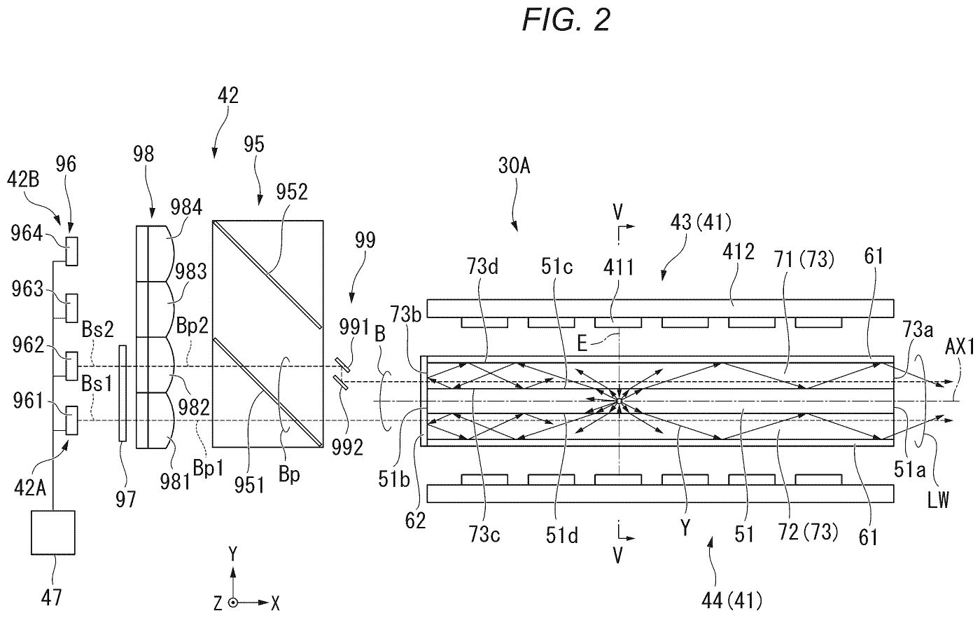

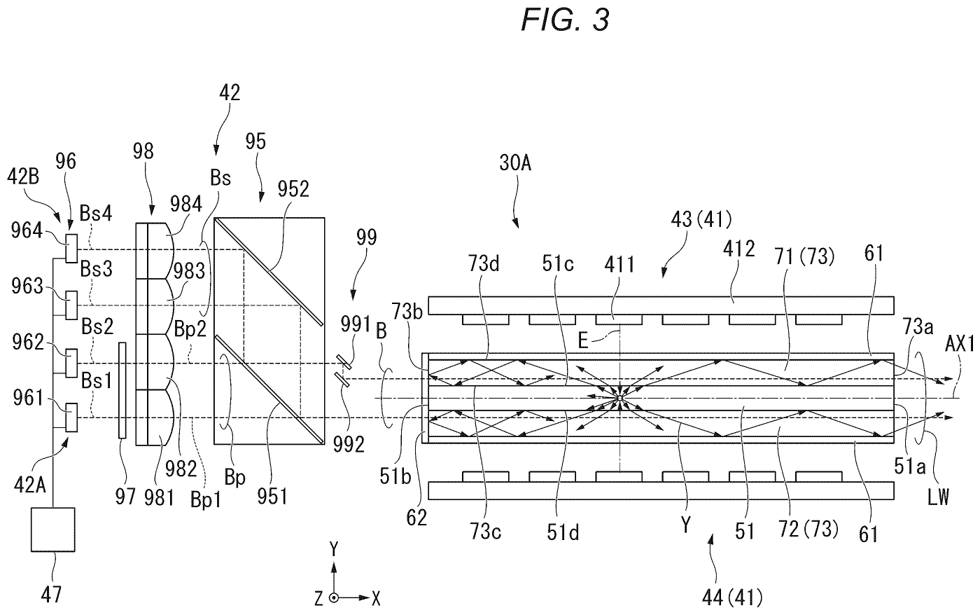

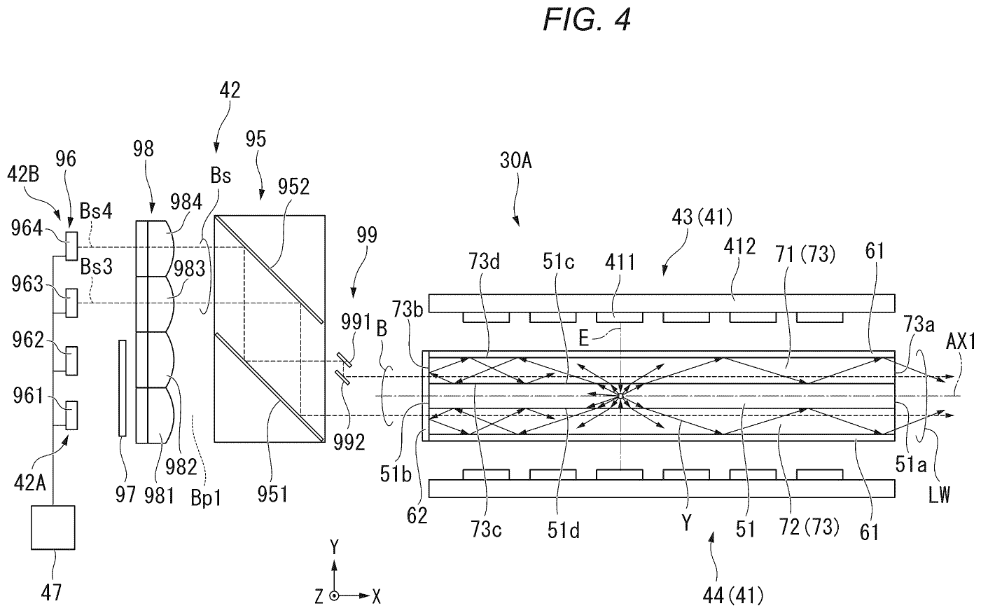

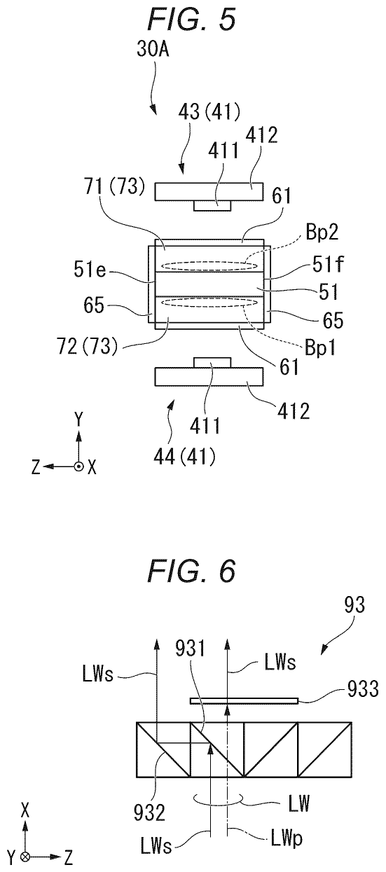

FIGS. 2 to 4 are cross-sectional views of the light source apparatus 30A according to the present embodiment. FIG. 2 shows a state in which blue light B is emitted in a first period. FIG. 3 shows a state in which the blue light B is emitted in a second period. FIG. 4 shows a state in which the blue light B is emitted in a third period. FIG. 5 is a cross-sectional view of the light source apparatus 30A taken along the line V-V in FIG. 2. As will be described in detail later, the state in which the blue light B is emitted temporally changes.

The light source apparatus 30A according to the present embodiment includes a first light source 41, a wavelength converter 51, a first light guide 71, a second light guide 72, first optical layers 61, a second optical layer 62, a second light source 42, a controller 47, and reflection layers 65, as shown in FIGS. 2 to 5.

The first light source 41 includes a third light source 43 and a fourth light source 44. The third light source 43 and the fourth light source 44 each have the same configuration. The third light source 43 and the fourth light source 44 each include multiple light emitters 411. The multiple light emitters 411 are mounted on substrates 412. Note that the number of the light emitters 411 provided in the first light source 41 is not limited to a specific number.

The light emitters 411 each emit an excitation beam having a first wavelength band. The light emitters 411 are each configured with a light emitting diode (LED). Configuring each of the light emitters 411 with an LED allows reduction in cost and improvement in light emission efficiency of the light source apparatus 30A. The light emitters 411 are disposed so as to face the wavelength converter 51, and each emit the excitation beam toward the wavelength converter 51. The first wavelength band is, for example, a wavelength band ranging from 400 nm to 480 nm corresponding to colors ranging from violet to blue. The center wavelength of the first wavelength band is, for example, 455 nm. The multiple light emitters 411 are arranged along the X-axis direction, which is the longitudinal direction of the wavelength converter 51.

The third light source 43 outputs multiple excitation beams toward the wavelength converter 51 via the first light guide 71. The fourth light source 44 is disposed so as to face the third light source 43 with the wavelength converter 51 interposed therebetween. The fourth light source 44 outputs multiple excitation beams toward the wavelength converter 51 via the second light guide 72. The first light source 41 thus causes excitation light E having the first wavelength band and including the multiple excitation beams to enter the wavelength converter 51. The excitation light E in the present embodiment corresponds to the first light in the claims.

The wavelength converter 51 has a plate-like shape extending along the X-axis and has six surfaces. The sides of the wavelength converter 51 that extend along the X-axis are longer than the sides thereof that extend along the Y-axis and the Z-axis. The X-axis direction corresponds to the longitudinal direction of the wavelength converter 51. The Y-axis direction is a direction parallel to the shortest side of the sides of the wavelength converter 51. The sides along the Y-axis are shorter than the sides along the Z-axis. That is, the wavelength converter 51 has a rectangular cross-sectional shape taken along a plane along the YZ plane, as shown in FIG. 5.

The wavelength converter 51 has a first end surface 51a, a second end surface 51b, a first side surface 51c, a second side surface 51d, a third side surface 51e, and a fourth side surface 51f. The first end surface 51a and the second end surface 51b face each other in opposite directions in the X-axis direction along the longitudinal direction of the wavelength converter 51. In the present embodiment, the first end surface 51a is located on the +X side, which is one side in the X-axis direction. The second end surface 51b is located on the −X side, which is the other side in the X-axis direction. The first end surface 51a in the present embodiment corresponds to the first surface in the claims. The second end surface 51b in the present embodiment corresponds to the second surface in the claims.

The first side surface 51c and the second side surface 51d intersect with the first end surface 51a and the second end surface 51b and face each other in opposite directions in the Y-axis. In the present embodiment, the first side surface 51c is located on the +Y side, which is one side in the Y-axis direction. The second side surface 51d is located on the −Y side, which is the other side in the Y-axis direction. The excitation light E is incident on the first side surface 51c from the third light source 43 via the first light guide 71. The excitation light E is incident on the second side surface 51d from the fourth light source 44 via the second light guide 72. The first side surface 51c and the second side surface 51d in the present embodiment correspond to the third surface in the claims.

The third side surface 51e and the fourth side surface 51f intersect with the first end surface 51a and the second end surface 51b, intersect with the first side surface 51c and the second side surface 51d, and face each other in opposite directions in the Z-axis direction, as shown in FIG. 5. The third side surface 51e is located on the +Z side, which is one side in the Z-axis direction. The fourth side surface 51f is located on the −Z side, which is the other side in the Z-axis direction.

The wavelength converter 51 includes at least a yellow phosphor, and converts the excitation light E having the first wavelength band and output from the first light source 41 into yellow fluorescence Y having a second wavelength band different from the first wavelength band. As will be described later in detail, part of the yellow fluorescence Y generated in the wavelength converter 51 exits from the first side surface 51c into the first light guide 71, and another part of the yellow fluorescence Y exits from the second side surface 51d into the second light guide 72.

The wavelength converter 51 includes a ceramic phosphor configured with a polycrystalline phosphor that converts the excitation light E in terms of wavelength into the yellow fluorescence Y. The wavelength converter 51 is configured with a phosphor that scatters light, that is, what is called a scattering phosphor. The second wavelength band of the yellow fluorescence Y is a yellow wavelength band ranging, for example, from 490 to 750 nm. The center wavelength of the second wavelength band is, for example, 550 nm. That is, the fluorescence Y is yellow fluorescence including a red light component and a green light component. The yellow fluorescence Y in the present embodiment corresponds to the second light in the claims.

The wavelength converter 51 may contain a monocrystal phosphor in place of the polycrystalline phosphor. The wavelength converter 51 may instead be made of fluorescent glass. The wavelength converter 51 may still instead be made of a material in which a large number of phosphor particles are dispersed in a binder made of glass or resin. The wavelength converter 51 made of any of the materials described above converts the blue excitation light E into the yellow fluorescence Y.

Specifically, the material of the wavelength converter 51 includes, for example, an yttrium-aluminum-garnet-based (YAG-based) phosphor. Consider YAG:Ce, which includes cerium (Ce) as an activator, by way of example, and the wavelength converter 51 is made, for example, of a material produced by mixing raw powder materials including Y₂O₃, Al₂O₃, CeO₃, and other constituent elements with one another and causing the mixture to go through a solid-phase reaction; Y—Al—O amorphous particles produced by using a coprecipitation method, a sol-gel method, or any other wet method; or YAG particles produced by using a spray-drying method, a flame-based thermal decomposition method, thermal plasma method, or any other gas-phase method.

The first optical layers 61 are disposed between the first light source 41 and the wavelength converter 51. That is, the first optical layers 61 are disposed between the third light source 43 and the wavelength converter 51, and between the fourth light source 44 and the wavelength converter 51. The first optical layers 61 have an optical characteristic of transmitting the excitation light E and reflecting the yellow fluorescence Y. The first optical layers 61 are each configured, for example, with a dielectric multilayer film. The first optical layers 61 are disposed on a second side surface 73d of a light transmissive member 73, which will be described later, the second side surface 73d being the surface facing the first light source 41.

The first light guide 71 and the second light guide 72 are disposed between the first optical layers 61 and the wavelength converter 51. That is, the first light guide 71 is disposed between the first optical layer 61 that faces the third light source 43 and the first side surface 51c of the wavelength converter 51. The second light guide 72 is disposed between the first optical layer 61 that faces the fourth light source 44 and the second side surface 51d of the wavelength converter 51. The first light guide 71 and the second light guide 72 each have the same configuration.

The first light guide 71 and the second light guide 72 each guide the excitation light E output from the first light source 41, the yellow fluorescence Y, into which the excitation light E is converted by the wavelength converter 51, and the blue light B output from the second light source 42. In the present embodiment, the first light guide 71 and the second light guide 72 are each configured with the light transmissive member 73, which transmits the excitation light E, the yellow fluorescence Y, and the blue light B. The light transmissive member 73 is a plate-shaped member and is bonded to each of the first side surface 51c and the second side surface 51d of the wavelength converter 51 with an optical adhesive (not shown). The first light guide 71 and the second light guide 72 in the present embodiment correspond to the light guide in the claims.

The light transmissive member 73 is made of a light transmissive material, for example, borosilicate glass such as BK7, quartz, synthetic quartz, quartz crystal, SiC, GaN, MgO, YAG, sapphire, and diamond. The light transmissive member 73 needs to be made of a material capable of transmitting the excitation light E, the yellow fluorescence Y, and the blue light B, as described above. The light transmissive member 73 has a plate-like shape extending along the X-axis. The light transmissive member 73 has a rectangular cross-sectional shape taken along a plane along the YZ plane and is elongated in the X-axis direction, as shown in FIG. 3. Out of the two end surfaces of the light transmissive member 73, which intersect with the X-axis, it is referred to as that the end surface facing the first end surface 51a of the wavelength converter 51 is a first end surface 73a, and that the end surface facing the second end surface 51b of the wavelength converter 51 is a second end surface 73b, as shown in FIG. 2. Out of the side surfaces of the light transmissive member 73, it is referred to as that the side surface in contact with the first side surface 51c and the second side surface 51d of the wavelength converter 51 is a first side surface 73c, and that the side surface opposite the first side surface 73c is the second side surface 73d. Note that the light transmissive member 73 may have a shape other than a plate-like shape (cuboidal shape).

It is desirable that the thermal conductivity of the light transmissive member 73 is higher than the thermal conductivity of the wavelength converter 51. Examples of the material of the light transmissive member 73 that satisfies the condition described above include SiC, GaN, MgO, YAG, sapphire, and diamond. According to the configuration described above, since heat of the wavelength converter 51 is efficiently transferred to the light transmissive member 73, an increase in temperature of the wavelength converter 51 can be suppressed. A decrease in conversion efficiency due to an increase in the temperature of the wavelength converter 51 can thus be suppressed.

The second light source 42 includes a light emitter array 96, a half-wave plate 97, a parallelizing system 98, a light combiner 95, and a light flux width reducing system 99.

The light emitter array 96 includes a first light emitter 961, a second light emitter 962, a third light emitter 963, and a fourth light emitter 964. The four light emitters are arranged in a row along the Y-axis direction, and the first light emitter 961, the second light emitter 962, the third light emitter 963, and the fourth light emitter 964 are disposed in this order from the −Y side toward the +Y side. The number of the light emitters provided in the light emitter array 96 is four in the present embodiment, but is not limited to a specific number.

The light emitters 961, 962, 963, and 964 output blue beams Bs1, Bs2, Bs3, and Bs4 having a third wavelength band toward the light transmissive member 73. The light emitters 961, 962, 963, and 964 are each configured with a chip-shaped laser diode (LD) that emits a blue beam. Configuring the light emitters 961, 962, 963, and 964 with LDs, which are point light sources, allows the parallelizing system 98 to produce parallelized light. The third wavelength band is, for example, a blue wavelength band ranging from 440 nm to 450 nm. The blue beams Bs1, Bs2, Bs3, and Bs4 are each S-polarized light. Note that the S-polarized light or P-polarized light described below refers to the polarization direction with respect to a polarization separation mirror 951 of the light combiner 95, which will be described later.

The light emitters 961, 962, 963, and 964 are each so disposed that the light emitting surface of the laser diode chip faces the +X side, that the long-side direction of the rectangular light emitting surface coincides with the Y-axis direction, and that the short-side direction of the light emitting surface coincides with the Z-axis direction. The center axes of the blue beams Bs1, Bs2, Bs3, and Bs4 emitted from the light emitters 961, 962, 963, and 964 are parallel to the X-axis. The angles of divergence of the blue beams Bs1, Bs2, Bs3, and Bs4 in the plane including the Y-axis direction differ from those in the plane including the Z-axis direction, and the angle of divergence in the plane including the Z-axis direction is sufficiently greater than the angle of divergence in the plane including the Y-axis direction. The blue beams Bs1 and Bs2 therefore have an elongated elliptical cross-sectional shape perpendicular to the center axes of the blue beams Bs1 and Bs2, with the major axis direction of the elliptical shapes coinciding with the Z-axis direction, the minor axis direction of the elliptical shapes coinciding with the Y-axis direction, as shown in FIG. 5.

The half-wave plate 97 is disposed on the light exiting side of the first light emitter 961 and the second light emitter 962. The half-wave plate 97 imparts a phase difference of about half of the wavelength of the blue beams Bs1 and Bs2. Therefore, the S-polarized blue beam Bs1 emitted from the first light emitter 961 is converted into a P-polarized blue beam Bp1 when passing through the half-wave plate 97, and enters the parallelizing system 98. The S-polarized blue beam Bs2 emitted from the second light emitter 962 is converted into a P-polarized blue beam Bp2 when passing through the half-wave plate 97, and enters the parallelizing system 98. On the other hand, no half-wave plate 97 is disposed on the light exiting side of the third light emitter 963 and the fourth light emitter 964. The S-polarized blue beams Bs3 and Bs4 emitted from the third light emitter 963 and the fourth light emitter 964 therefore enter the parallelizing system 98 with the state of polarization of the beams unchanged.

In the following description, the first light emitter 961, the second light emitter 962, and the half-wave plate 97 are collectively defined as a first light emitting section 42A. The third light emitter 963 and the fourth light emitter 964 are collectively defined as a second light emitting section 42B. The first light emitting section 42A therefore emits blue light Bp configured with the P-polarized blue beams Bp1 and Bp2. The second light emitting section 42B emits blue light Bs configured with the S-polarized blue beams Bs3 and Bs4. That is, the second light source 42 includes the first light emitting section 42A, which emits the P-polarized blue light Bp, and the second light emitting section 42B, which emits the S-polarized blue light Bs. The blue light B output from the second light source 42 includes at least one of the P-polarized blue light Bp and the S-polarized blue light Bs. The blue light B in the present embodiment corresponds to the third light in the claims. The P-polarized blue light Bp in the present embodiment corresponds to the fourth light in the first polarization state in the claims. The S-polarized blue light Bs in the present embodiment corresponds to the fifth light in the second polarization state in the claims.

The parallelizing system 98 is disposed on the light exiting side of the light emitter array 96. The parallelizing system 98 includes a first parallelizing element 981, a second parallelizing element 982, a third parallelizing element 983, and a fourth parallelizing element 984. The parallelizing elements 981, 982, 983, and 984 are each configured with a collimator lens. The first parallelizing element 981 is disposed on the light exiting side of the first light emitter 961 and parallelizes the blue beam Bp1 emitted from the first light emitter 961. The second parallelizing element 982 is disposed on the light exiting side of the second light emitter 962 and parallelizes the blue beam Bp2 emitted from the second light emitter 962. The third parallelizing element 983 is disposed on the light exiting side of the third light emitter 963 and parallelizes the blue beam Bs3 emitted from the third light emitter 963. The fourth parallelizing element 984 is disposed on the light exiting side of the fourth light emitter 964 and parallelizes the blue beam Bs4 emitted from the fourth light emitter 964.

The light combiner 95 is disposed on the light exiting side of the parallelizing system 98. The light combiner 95 includes a polarization separation mirror 951 and a reflection mirror 952. The polarization separation mirror 951 is disposed in the optical path of the P-polarized blue light Bp emitted from the first light emitting section 42A, transmits the P-polarized light, and reflects the S-polarized light. The reflection mirror 952 is disposed in the optical path of the S-polarized blue light Bs emitted from the second light emitting section 42B, and reflects the S-polarized blue light Bs. The P-polarized blue light Bp emitted from the first light emitting section 42A therefore passes through the polarization separation mirror 951 and travels toward the +X side. The S-polarized blue light Bs emitted from the second light emitting section 42B is reflected off the reflection mirror 952, travels toward the −Y side, is then reflected off the polarization separation mirror 951, and travels toward the +X side. The light combiner 95 thus combines the P-polarized blue light Bp emitted from the first light emitting section 42A with the S-polarized blue light Bs emitted from the second light emitting section 42B. According to the configuration described above, since the P-polarized blue light Bp and the S-polarized blue light Bs are combined with each other by the light combiner 95, the blue light B, which is the mixture of light having different polarization states, can be efficiently incident on the second end surface 73b of the light transmissive member 73.

The luminous flux width reducing system 99 is disposed on the light exiting side of the light combiner 95. The luminous flux width reducing system 99 includes a first reflection mirror 991 and a second reflection mirror 992. The first reflection mirror 991 is disposed in the optical path of the blue beam Bp2 emitted from the second light emitter 962. The second reflection mirror 992 is disposed on the −Y side of the first reflection mirror 991. Therefore, the blue beam Bp2 emitted from the second light emitter 962 passes through the polarization separation mirror 951, is then reflected off the first reflection mirror 991, is further reflected off the second reflection mirror 992, and travels toward the +X side. The blue beam Bs4 emitted from the fourth light emitter 964 is reflected off the reflection mirror 952, is reflected off the polarization separation mirror 951, is then reflected off t reflection mirror 991, is further reflected off the second reflection mirror 992, and travels toward the +X side. The luminous flux width reducing system 99 thus reduces the luminous flux width of blue light B including the blue beams Bp1, Bp2, Bs3, and Bs4 emitted from the four light emitters 961, 962, 963, and 964. Note that the luminous flux width reducing system 99 may not be necessarily provided.

The controller 47 controls the light output state of the second light source 42. Specifically, the controller 47 adjusts the electric power supplied to each of the light emitters 961, 962, 963, and 964, which constitute the second light source 42, to control turning on or off the light emitters 961, 962, 963, and 964 and the amount of the blue beams Bp1, Bp2, Bs3, and Bs4 emitted from the light emitters 961, 962, 963, and 964. The controller 47 thus temporally changes the ratio between the amount of the P-polarized blue light Bp emitted from the first light emitting section 42A and the amount of the S-polarized blue light Bs emitted from the second light emitting section 42B. A specific example of a pattern in accordance with which the ratio is changed will be described later. The controller 47 includes a CPU.

The second optical layer 62 is disposed on the −X side of the wavelength converter 51, the first light guide 71, and the second light guide 72. Specifically, the second optical layer 62 is provided so as to face the second end surface 51b of the wavelength converter 51 and the second end surface 73b of the light transmissive member 73. The second optical layer 62 is configured with a dielectric multilayer film that transmits blue light and reflects yellow light. Therefore, the blue light B output from the second light source 42 passes through the second optical layer 62, and enters the first light guide 71 and the second light guide 72. The yellow fluorescence Y, into which the excitation light E is converted by the wavelength converter 51, propagates toward the −X side in the first light guide 71 and the second light guide 72, is reflected off the second optical layer 62 when incident on the second optical layer 62, and propagates through the interior of the first light guide 71 and the second light guide 72 toward the +X side.

The reflection layers 65 are disposed on opposite sides of the first light guide 71, the second light guide 72, and the wavelength converter 51 in the Z-axis direction, as shown in FIG. 5. The reflection layers 65 reflect the excitation light E, the yellow fluorescence Y, and the blue light B. The reflection layers 65 therefore reflect the excitation light E that does not directly enter the wavelength converter 51 but is incident on the reflection layers 65 to cause the reflected excitation light E to enter the wavelength converter 51. The efficiency of the conversion from the excitation light E into the yellow fluorescence Y can thus be increased. The reflection layers 65 reflect the yellow fluorescence Y and the blue light B propagating through the interior of the first light guide 71 and the second light guide 72. Loss of the yellow fluorescence Y and the blue light B can thus be suppressed. The reflection layers 65 are each configured, for example, with a metal film, a dielectric multilayer film, or a scattering layer.

The optical integration system 90 is provided on the light exiting side of the light source apparatus 30A, as shown in FIG. 1. The optical integration system 90 includes a first lens array 91 and a second lens array 92. The optical integration system 90, along with the superimposing system 94, functions as a homogenizing illumination system that homogenizes the intensity distribution of the white light LW output from the light source apparatus 30A at the light modulators 400R, 400G, and 400B, which are illumination receiving regions. The white light LW output from the light source apparatus 30A enters the first lens array 91.

The first lens array 91 includes multiple first lenses 91a. The multiple first lenses 91a are arranged in a matrix in a plane parallel to the YZ-plane perpendicular to the optical axis AX1 of the illuminator 20. The multiple first lenses 91a divide the white light LW output from the light source apparatus 30A into multiple sub-luminous fluxes. The first lenses 91a each have a quadrangular shape substantially similar to the shape of an image formation region of each of the light modulators 400R, 400G, and 400B. The sub-luminous fluxes output from the first lens array 91 are therefore efficiently incident on the image formation region of each of the light modulators 400R, 400G, and 400B.

The white light LW output from the first lens array 91 travels toward the second lens array 92. The second lens array 92 is disposed so as to face the first lens array 91. The second lens array 92 includes multiple second lenses 92a corresponding to the multiple first lenses 91a of the first lens array 91. The second lens array 92, along with the superimposing system 94, forms images of the multiple first lenses 91a of the first lens array 91 in the vicinity of the image formation region of each of the light modulators 400R, 400G, and 400B. The multiple second lenses 92a are arranged in a matrix in a plane parallel to the YZ plane perpendicular to the optical axis AX1 of the illuminator 20. The superimposing system 94 is configured with a single convex lens.

In the present embodiment, the first lenses 91a of the first lens array 91 and the second lenses 92a of the second lens array 92 have the same size, but may have sizes different from each other. Furthermore, in the present embodiment, the first lenses 91a of the first lens array 91 and the second lenses 92a of the second lens array 92 are disposed at positions where the optical axes thereof coincide with each other, but may be disposed with the optical axes thereof shifted from each other.

FIG. 6 illustrates an effect of the polarization converter 93.

The polarization converter 93 converts the polarization directions of the white light LW output from the second lens array 92. Specifically, the polarization converter 93 converts each of the sub-luminous fluxes, into which the white light LW is divided by the first lens array 91 shown in FIG. 1 and which are output from the second lens array 92, into linearly polarized light. The polarization converter 93 includes polarization separating layers 931, reflection layers 932, and a phase retarding layer 933, as shown in FIG. 6. The polarization separation layers 931 transmit P-polarized white light LWp out of the polarized components contained in the white light LW output from the light source apparatus 30A with no change in the state of polarization, and reflects S-polarized white light LWs in a direction perpendicular to the optical axis AX1 shown in FIG. 1 (Z-axis direction). The reflection layers 932 reflect the S-polarized white light LWs reflected off the polarization separation layers 931 in a direction parallel to the optical axis AX1 (X-axis direction). The phase retarding layer 933 is configured with a half-wave plate, and converts the P-polarized white light LWp passing through the polarization separation layers 931 into the S-polarized white light LWs.

An effect of the light source apparatus 30A according to the present embodiment will be described below.

In the source light apparatus 30A, the excitation light E output from the first light source 41 passes through the first optical layers 61 and the light transmissive member 73 and enters the wavelength converter 51, as shown in FIGS. 2 to 4.

When the excitation light E enters the wavelength converter 51, the phosphor contained in the wavelength converter 51 is excited, and emits the yellow fluorescence Y from random light emission points. In this process, the excitation light E having entered the phosphor is diffused and propagates to a region wider than the region on which the excitation light E is incident, so that the width of the region from which the yellow fluorescence Y is emitted widens, that is, what is called a smear of the yellow fluorescence Y is produced.

The yellow fluorescence Y incident on the first side surface 51c and the second side surface 51d from the light emission points in the wavelength converter 51 at angles of incidence smaller than the critical angle exits out of the wavelength converter 51, enters the light transmissive member 73, and propagates through the interior of the light transmissive member 73. In this process, the fluorescence Y traveling toward the +X side is reflected off the first optical layers 61 and enters the wavelength converter 51 again. In the present embodiment, since the wavelength converter 51 is configured with a scattering phosphor, the yellow fluorescence Y is scattered in the wavelength converter 51, and exits out of the wavelength converter 51 into the light transmissive member 73 again, propagates through the light transmissive member 73, and then exits out of the light transmissive member 73 via the first end surface 73a.

The yellow fluorescence generated in the wavelength converter 51 and incident on the first side surface 51c and the second side surface 51d of the wavelength converter 51 at angles of incidence greater than or equal to the critical angle is temporarily totally reflected off the first side surface 51c and the second side surface 51d of the wavelength converter 51. In the present embodiment, however, since the wavelength converter 51 is configured with a scattering phosphor, the traveling directions of the yellow fluorescence Y change inside the wavelength converter 51, so that the angles of incidence of the yellow fluorescence Y with respect to the first side surface 51c and the second side surface 51d of the wavelength converter 51 change. As a result, the yellow fluorescence Y exits out of the wavelength converter 51 into the light transmissive member 73, propagates through the light transmissive member 73, and then exits out of the light transmissive member 73 via the first end surface 73a.

The yellow fluorescence Y traveling through the light transmissive member 73 toward the −X side and reaching the second optical layer 62 is reflected off the second optical layer 62, then travels toward the +X side, and follows the same path as the yellow fluorescence Y described above. That is, the yellow fluorescence Y propagates through the interior of the light transmissive member 73 or the wavelength converter 51 while being repeatedly reflected off the first optical layers 61 and the first side surface 51c or the second side surface 51d of the wavelength converter 51, and exits out of the light transmissive member 73 via the first end surface 73a or out of the wavelength converter 51 via the first end surface 51a.

In contrast, regarding the blue light B output from the second light source 42, the amount of the blue beam emitted from each of the light emitters 961, 962, 963, and 964 is controlled by the controller 47, so that the ratio between the amount of the P-polarized blue light Bp emitted from the first light emitting section 42A and the amount of the S-polarized blue light Bs emitted from the second light emitting section 42B temporally changes, as described above.

An example of a temporally changing pattern of the ratio between the amount of the P-polarized blue light Bp and the amount of the S-polarized blue light Bs will be described below.

In the present example, the amount of the blue light Bp: the amount of the blue light Bs is set to 100%: 0% in the first period. In the first period, the first light emitter 961 and the second light emitter 962 emit light, and the third light emitter 963 and the fourth light emitter 964 emit no light, as shown in FIG. 2. Therefore, only the P-polarized blue light Bp including the blue beam Bp1 emitted from the first light emitter 961 and the blue beam Bp2 emitted from the second light emitter 962 is incident on the second end surface 73b of the light transmissive member 73.

In the second period, the amount of the blue light Bp: the amount of the blue light Bs is set to 50%: 50%. In the second period, the first light emitter 961, the second light emitter 962, the third light emitter 963, and the fourth light emitter 964 all emit light, as shown in FIG. 3. Therefore, both the P-polarized blue light Bp including the blue beam Bp1 emitted from the first light emitter 961 and the blue beam Bp2 emitted from the second light emitter 962 and the S-polarized blue light Bs including the blue beam Bs3 emitted from the third light emitter 963 and the blue beam Bs4 emitted from the fourth light emitter 964 are incident on the second end surface 73b of the light transmissive member 73.

In the third period, the amount of the blue light Bp: the amount of the blue light Bs is set to 0%: 100%. In the third period, the third light emitter 963 and the fourth light emitter 964 emit light, and the first light emitter 961 and the second light emitter 962 emit no light, as shown in FIG. 4. Therefore, only the S-polarized blue light Bs including the blue beam Bs3 emitted from the third light emitter 963 and the blue beam Bs4 emitted from the fourth light emitter 964 is incident on the second end surface 73b of the light transmissive member 73.

The three periods described above may be repeated in one direction, for example, the first period→the second period→the third period→the first period→the second period→the third period . . . . The three periods may instead be repeated back and forth, such as the first period→the second period→the third period→the second period→the first period→the second period→the third period, . . . . As described above, when the three periods are cyclically repeated, the frequency at which the three periods are repeated is desirably 60 Hz or higher. That is, the total period of the three periods is desirably 1/60 seconds or shorter. According to the configuration described above, flicker of a projection image on the screen can be suppressed. In place of the configuration in which the three periods are cyclically repeated, the ratio between the amount of the P-polarized blue light Bp and the amount of the S-polarized blue light Bs may be so changed that the three periods randomly occur. Still instead, the ratio between the amount of the P-polarized blue light Bp and the amount of the S-polarized blue light Bs may not change discretely but may change continuously.

It is further desirable that the amount of the P-polarized blue light Bp in the first period, the sum of the amount of the P-polarized blue light Bp and the amount of the S-polarized blue light Bs in the second period, and the amount of the S-polarized blue light Bs in the third period are equal to each other. That is, it is desirable that the sum of the amount of the P-polarized blue light Bp be equal to the amount of the S-polarized blue light Bs over the entire period. According to the configuration described above, since the amount of the blue light B output from the light source apparatus 30A does not change over the entire period, the flicker of a projection image on the screen can be suppressed.

The blue light B incident on the second end surface 73b of the light transmissive member 73 may propagate through the interior of the first light guide 71 and the second light guide 72 without entering the wavelength converter 51 and may exit via the first end surface 73a of the light transmissive member 73 as the blue light B over the entire period. Instead, out of the blue light B incident on the second end surface 73b of the light transmissive member 73, part of the blue light B may enter the wavelength converter 51, be converted into the yellow fluorescence Y, and propagate through the light guides 71 and 72, and the other part of the blue light B may propagate through the light guides 71 and 72 as the blue light B without being converted into the yellow fluorescence Y, and exit via the first end surface 73a of the light transmissive member 73 as the white light LW. Note that the blue light B incident on the second end surface 73b of the light transmissive member 73 may be parallelized light, converging light, or diverging light.

The light source apparatus 30A can thus output the white light LW, which is the combination of the yellow fluorescence Y output via the first end surface 51a of the wavelength converter 51 and the first end surface 73a of the light transmissive member 73 and the blue light B output via the first end surface 73a of the light transmissive member 73. The light source apparatus 30A, which therefore outputs the white light LW having small etendue, can reduce the loss of the white light LW in the optical integration system 90 and other optical members disposed downstream from the light source apparatus 30A. As a result, the efficiency at which the white light LW is used in the light source apparatus 30A can be improved.

### Advantages of First Embodiment

The light source apparatus 30A according to the present embodiment includes the first light source 41, which outputs the excitation light E, the wavelength converter 51, which converts the excitation light E into the yellow fluorescence Y, the second light source 42, which outputs the blue light B, the first light guide 71 and the second light guide 72, which are disposed between the first light source 41 and the wavelength converter 51 and guide the excitation light E, the yellow fluorescence Y, and the blue light B, and the controller 47, which controls the light output state of the second light source 42. The wavelength converter 51 has the first end surface 51a and the second end surface 51b, which face each other in opposite directions, and the first side surface 51c and the second side surface 51d, which intersect with the first end surface 51a and the second end surface 51b. The excitation light E output from the first light source 41 enters the wavelength converter 51 via the first light guide 71 and the second light guide 72 and then via the first side surface 51c and the second side surface 51d. The yellow fluorescence Y travels through the light guides 71 and 72 and exits from the first end surface 73a. The blue light B includes the P-polarized blue light Bp and the S-polarized blue light Bs, and is incident on the second end surface 73b of each of the light guides 71 and 72. The second light source 42 includes the first light emitting section 42A, which emits the P-polarized blue light Bp, and the second light emitting section 42B, which emits the S-polarized blue light Bs. The first light emitting section 42A and the second light emitting section 42B each include a laser diode. The controller 47 temporally changes the ratio between the amount of the P-polarized blue light Bp emitted from the first light emitting section 42A and the amount of the S-polarized blue light Bs emitted from the second light emitting section 42B.

The illuminator 20 according to the present embodiment includes the light source apparatus 30A, and the polarization converter 93, which changes the polarization state of the white light LW output from the light source apparatus 30A.

In a projector that outputs laser light, it is inevitable that speckles are produced in a projection image on a screen due to interference of the laser light. For example, in the illuminator disclosed in JP-A-2016-173391 described above, the blue light is diffused by using the fixed diffusive reflector. In this method, the blue light has a wide light orientation distribution, but it is difficult to sufficiently suppress the speckles. As a method for suppressing the speckles, it is conceivable to change the speckle pattern on the screen at high speed. In this case, it is conceivable, for example, to employ a method for diffusing the laser light by using a rotary diffuser plate. In this method, however, there are problems such as an increase in size of the illuminator due to the presence of the rotary diffuser plate, and generation of noise and vibration.

To address the problems, in the light source apparatus 30A according to the present embodiment, the polarization state of the blue light B output from the second light source 42 is temporally switched at high speed, for example, in the three periods: only the P-polarized blue light Bp (100%) is output in the first period; the P-polarized blue light Bp and the S-polarized blue light Bs (50%: 50%) are equally output in the second period; and only the S-polarized blue light Bs (100%) is output in the third period. Since the polarization state of the blue light B temporally changes, the speckle pattern changes over time at high speed, so that the speckles are less likely to be visually recognized by an observer. A projector 10 that suppresses speckles and excels in display quality is thus achieved. Furthermore, since it is not necessary to add a constituent part such as a rotary diffuser plate, problems such as an increase in size of the illuminator due to measures taken against speckles, and generation of noise and vibration do not occur.

Since the illuminator 20 according to the present embodiment includes the polarization converter 93 having the configuration shown in FIG. 6, the position where the white light LWs from the polarization converter 93 is output changes in correspondence with each of the period in which only the P-polarized blue light Bp is output, the period in which both the P-polarized blue light Bp and the S-polarized blue light Bs are output, and the period in which only the S-polarized blue light Bs is output. The spatial distribution of the white light LWs in an optical system downstream from the polarization converter 93 thus temporally changes. As described above, since the temporal change of the spatial distribution of the white light LWs also temporally changes the speckle pattern, the speckles can be more effectively suppressed.

All the four light emitters 961, 962, 963, and 964 may emit light having the same center wavelength, or some of the light emitters may emit multiple types of light having center wavelengths different from the center wavelengths of light from the other light emitters. For example, the average wavelength of the center wavelengths of the first light emitter 961 and the second light emitter 962, which constitute the first light emitting section 42A, may differ from the average wavelength of the center wavelengths of the third light emitter 963 and the fourth light emitter 964, which constitute the second light emitting section 42B, and the difference between the two average wavelengths may be 2 nm or greater. According to the configuration described above, since the center wavelengths of the blue light Bp and Bs corresponding to the periods change by 2 nm or greater, the speckle pattern temporally changes, so that the speckles can be more effectively suppressed. The present discloser has ascertained that when the wavelength of the blue light varies by 2 nm or greater, the speckles are suppressed by the change in the speckle pattern. The average wavelength of the center wavelength of the light from the first light emitter 961 and the center wavelength of the light from the second light emitter 962 in the present embodiment corresponds to the first center wavelength in the claims. The average wavelength of the center wavelength of the light from the third light emitter 963 and the center wavelength of the light from the fourth light emitter 964 in the present embodiment corresponds to the second center wavelength in the claims.

Furthermore, the center wavelength of the light from the first light emitter 961 and the center wavelength of the light from the second light emitter 962 may be equal to each other or differ from each other. When the center wavelength of the light from the first light emitter 961 and the center wavelength of the light from the second light emitter 962 differ from each other, the difference between the center wavelength of the light from the first light emitter 961 and the center wavelength of the light from the second light emitter 962 is desirably 2 nm or greater. According to the configuration described above, since the P-polarized blue light Bp emitted from the first light emitting section 42A includes the two blue beams Bp1 and Bp2 having the center wavelengths separate from each other by 2 nm or greater, the coherency of the blue light Bp decreases even in a single period, so that the speckles can be more effectively suppressed. The center wavelength of the light from the first light emitter 961 in the present embodiment corresponds to the third center wavelength in the claims. The center wavelength of the light from the second light emitter 962 in the present embodiment corresponds to the fourth center wavelength in the claims.

Similarly, the center wavelength of the light from the third light emitter 963 and the center wavelength of the light from the fourth light emitter 964 may be equal to each other or differ from each other. When the center wavelength of the light from the third light emitter 963 and the center wavelength of the light from the fourth light emitter 964 differ from each other, the difference between the center wavelength of the light from the third light emitter 963 and the center wavelength of the light from the fourth light emitter 964 is desirably 2 nm or greater. According to the configuration described above, since the S-polarized blue light Bs emitted from the second light emitting section 42B includes the two blue beams Bs3 and Bs4 having the center wavelengths separate from each other by 2 nm or greater, the coherency of the blue light Bs decreases even in a single period, so that the speckles can be more effectively suppressed. The center wavelength of the light from the third light emitter 963 in the present embodiment corresponds to the fifth center wavelength in the claims. The center wavelength of the light from the fourth light emitter 964 in the present embodiment corresponds to the sixth center wavelength in the claims.

From the above description, as an example, the center wavelength of the light from the first light emitter 961 may be 443 nm, the center wavelength of the light from the second light emitter 962 may be 445 nm, the center wavelength of the light from the third light emitter 963 may be 445 nm, and the center wavelength of the light from the fourth light emitter 964 may be 447 nm. In this case, the following conditions are satisfied: the difference between the center wavelength of the light from the first light emitter 961 and the center wavelength of the light from the second light emitter 962 is 2 nm or greater; the difference between the center wavelength of the light from the third light emitter 963 and the center wavelength of the light from the fourth light emitter 964 is 2 nm or greater; and the difference between the average wavelength of the light from the first light emitting section 42A and the average wavelength of the light from the second light emitting section 42B is 2 nm or greater.

In the light source apparatus 30A according to the present embodiment, the wavelength converter 51 has the first side surface 51c and the second side surface 51d, which face each other in opposite directions, the light guide includes the first light guide 71 disposed so as to face the first side surface 51c and the second light guide 72 disposed so as to face the second side surface 51d, and the first light source 41 includes the third light source 43, which causes the excitation light E to enter the wavelength converter 51 via the first light guide 71, and the fourth light source 44, which causes the excitation light E to enter the wavelength converter 51 via the second light guide 72.

According to the configuration described above, since the first side surface 51c and the second side surface 51d of the wavelength converter 51 are each in contact with the light transmissive member 73, heat of the wavelength converter 51 is efficiently transferred to the light transmissive member 73, so that an increase in the temperature of the wavelength converter 51 is suppressed. A decrease in wavelength conversion efficiency due to an increase in the temperature of the wavelength converter 51 can thus be suppressed. Furthermore, since the excitation light E output from each of the third light source 43 and the fourth light source 44 enters the wavelength converter 51 via the two side surfaces 51c and 51d thereof, a sufficient amount of the excitation light E can be ensured, so that a sufficient amount of the yellow fluorescence Y can be ensured.

The projector 10 according to the present embodiment includes the light source apparatus 30A, the light modulators 400R, 400G, and 400B, which modulate the light output from the light source apparatus 30A, and the projection optical apparatus 600, which projects the light modulated by the light modulators 400R, 400G, and 400B.

According to the configuration described above, since the light source apparatus 30A outputs the white light LW, it is not necessary to provide a light source apparatus that outputs blue light separately from the light source apparatus that outputs the yellow fluorescence, and a projector 10 having a highly efficient and simple configuration and excellent display quality can be realized.

### Second Embodiment

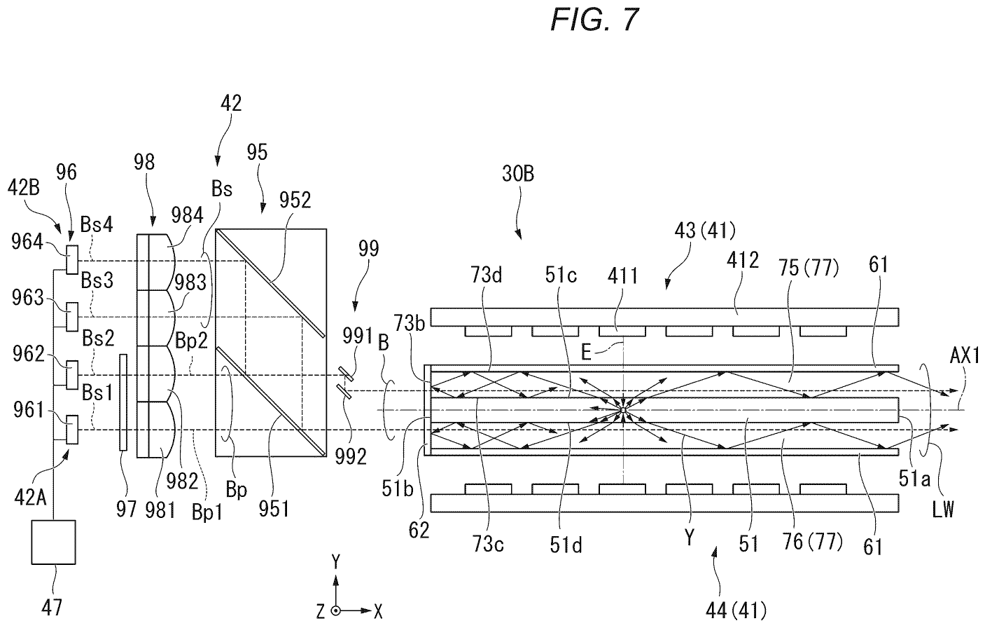

A second embodiment of the present disclosure will be described below with reference to FIG. 7.

The basic configuration of a light source apparatus according to the second embodiment is the same as that in the first embodiment, but the configuration of the light guide differs from that in the first embodiment. The basic configuration of the light source apparatus will therefore not be described.

FIG. 7 is a cross-sectional view of a light source apparatus 30B according to the second embodiment taken along the XY plane. In FIG. 7, elements common to those in the drawings used in the first embodiment have the same reference characters and will not be described.

The light source apparatus 30B according to the present embodiment includes the first light source 41, the wavelength converter 51, a first light guide 75, a second light guide 76, the first optical layers 61, the second optical layer 62, the second light source 42, the controller 47, and reflection layers (not shown), as shown in FIG. 7.

In the light source apparatus 30A according to the first embodiment, the first light guide 71 and the second light guide 72 are configured with the light transmissive member 73. In contrast, in the light source apparatus 30B according to the present embodiment, the first light guide 75 and the second light guide 76 are configured with an air layer 77. That is, the first optical layers 61 and the wavelength converter 51 are disposed separate from each other, and air is present between the first optical layers 61 and the wavelength converter 51. The yellow fluorescence Y, into which the excitation light E is converted by the wavelength converter 51, and the blue light B output from the second light source 42 are therefore output from a region of the air layer 77 that is a region facing the first end surface 51a.

The other configurations of the light source apparatus 30B are the same as those of the light source apparatus 30A according to the first embodiment.

### Advantages of Second Embodiment

Also in the present embodiment, since the temporal change in the polarization state of the blue light B temporally changes the speckle pattern, the same advantages as those provided by the first embodiment can be provided, for example, the speckles can be sufficiently suppressed.

In the present embodiment, since the first light guide 75 and the second light guide 76 are configured with the air layer 77, the difference in refractive index between the wavelength converter 51 and each of the light guides 75 and 76 is greater than that in the case where the first and second light guides are configured with a light transmissive member made, for example, of quartz. The angle at which the fluorescence Y is refracted when the fluorescence Y is output from the wavelength converter 51 into the light guides 75 and 76 therefore increases, so that the fluorescence Y travels in directions inclining by small angles with respect to the first side surface 51c and the second side surface 51d of the wavelength converter 51, that is, by small angles with respect to the X-axis. Since a region of each of the light guides 75 and 76 that is a region facing the first end surface 51a is open to the external space and does not have a refractive index interface, the fluorescence Y having reached the region of each of the light guides 75 and 76, which is a region facing the first end surface 51a, is output to the external space as it is without being reflected or refracted. The light source apparatus 30B according to the present embodiment can thus extract the yellow fluorescence Y at increased efficiency as compared with that in the first embodiment.

### Third Embodiment

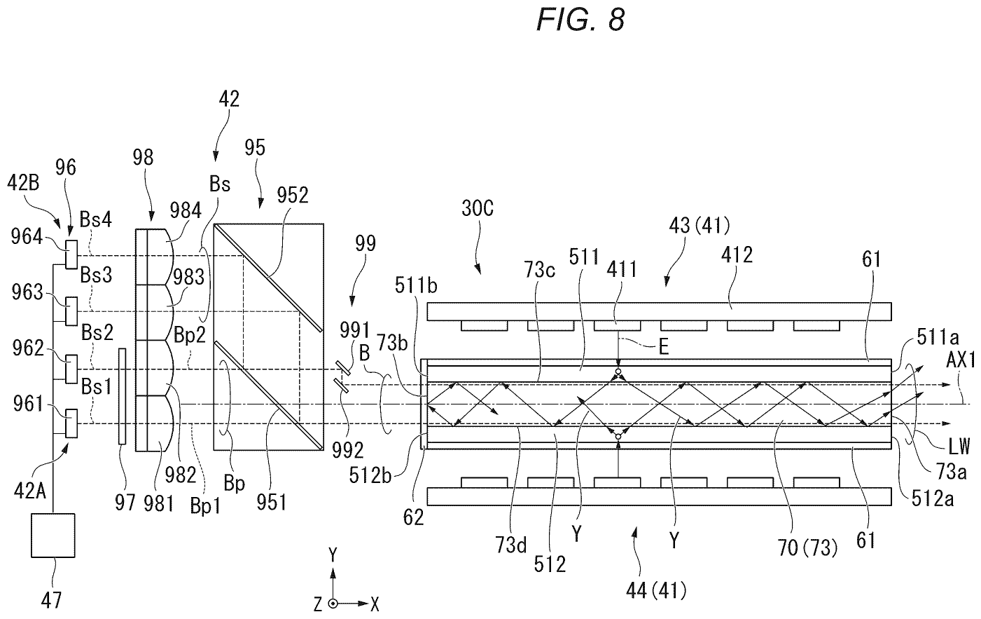

A third embodiment of the present disclosure will be described below with reference to FIG. 8.

The basic configuration of a light source apparatus according to the third embodiment is the same as that in the first embodiment, but the arrangement of the wavelength converter and the light guide differs from that in the first embodiment. The basic configuration of the light source apparatus will therefore not be described.

FIG. 8 is a cross-sectional view of a light source apparatus 30C according to the third embodiment taken along the XY plane. In FIG. 8, elements common to those in the drawings used in the first embodiment have the same reference characters and will not be described.

The light source apparatus 30C according to the present embodiment includes the first light source 41, a first wavelength converter 511, a second wavelength converter 512, a light guide 70, the first optical layers 61, the second optical layer 62, the second light source 42, the controller 47, and reflection layers (not shown), as shown in FIG. 8.

The light source apparatus 30C according to the present embodiment includes two wavelength converters, the first wavelength converter 511 and the second wavelength converter 512. The first wavelength converter 511 and the second wavelength converter 512 each have the same configuration and are disposed separate from each other in the Y-axis direction. The first wavelength converter 511 and the second wavelength converter 512 each convert the excitation light E output from the first light source 41 into the yellow fluorescence Y. The excitation light E output from the third light source 43 enters the first wavelength converter 511. The excitation light E output from the fourth light source 44 enters the second wavelength converter 512.

The light guide 70 is configured with a plate-shaped light transmissive member 73 made, for example, of quartz. The first wavelength converter 511 and the second wavelength converter 512 are bonded to two side surfaces 73c and 73d of the light transmissive member 73 with an optical adhesive. The yellow fluorescence Y, into which the excitation light E is converted by the first wavelength converter 511 and the second wavelength converter 512, is output from each of the wavelength converters 511 and 512, travels through the interior of the light guide 70, and exits out of the light guide 70 via the first end surface 73a.

The other configurations of the light source apparatus 30C are the same as those of the light source apparatus 30A according to the first embodiment.

### Advantages of Third Embodiment

Also in the present embodiment, since the temporal change in the polarization state of the blue light B temporally changes the speckle pattern, the same advantages as those provided by the first embodiment can be provided, for example, the speckles can be sufficiently suppressed.

### Fourth Embodiment

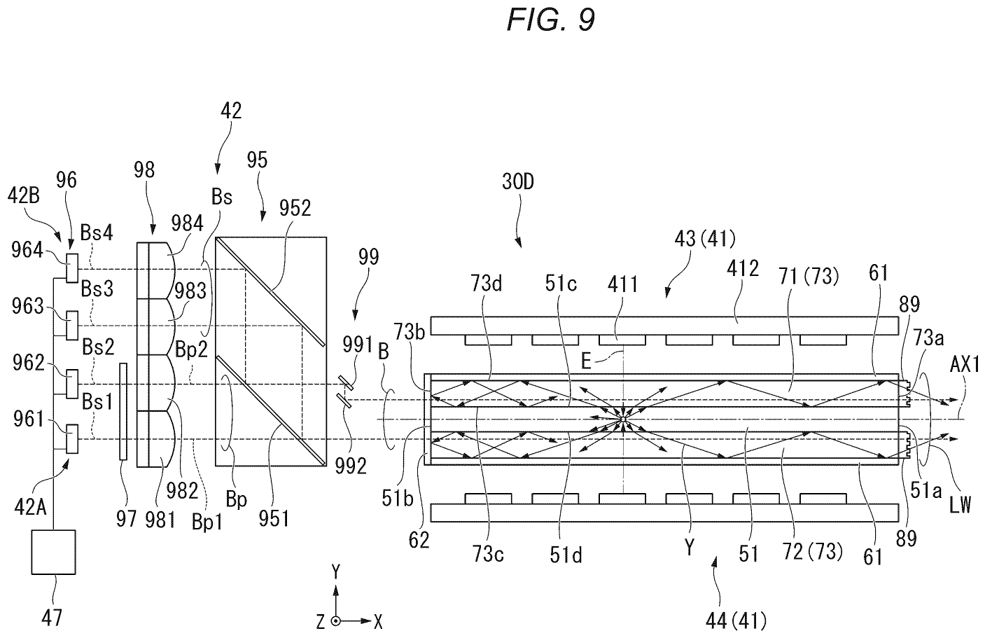

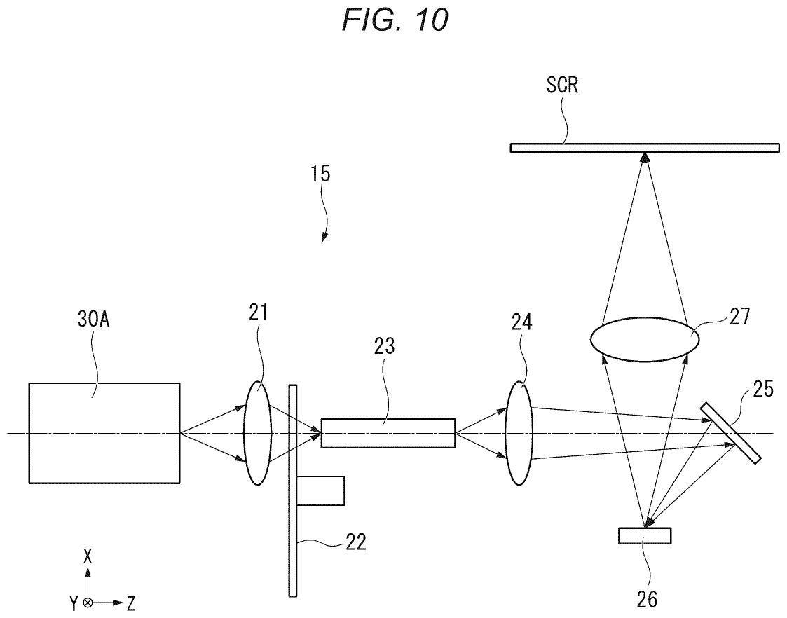

A fourth embodiment of the present disclosure will be described below with reference to FIG. 9.

The basic configuration of a light source apparatus according to the fourth embodiment is the same as that in the first embodiment, but the fourth embodiment differs from the first embodiment in that a light diffuser is added. The basic configuration of the light source apparatus will therefore not be described.

FIG. 9 is a cross-sectional view of a light source apparatus 30D according to the fourth embodiment taken along the XY plane. In FIG. 9, elements common to those in the drawings used in the first embodiment have the same reference characters and will not be described.

The light source apparatus 30D according to the present embodiment includes the first light source 41, the wavelength converter 51, the first light guide 75, the second light guide 76, the first optical layers 61, the second optical layer 62, the second light source 42, the controller 47, light diffusers 89, and reflection layers (not shown), as shown in FIG. 9.

The light diffusers 89 are disposed at the first end surface 73a of the light transmissive member 73, which is configured with the first light guide 71 and the second light guide 72. Specifically, the light diffusers 89 are bonded to the first end surface 73a of the light transmissive member 73 with an optical adhesive. The light diffusers 89 may each be made of frosted glass having a random uneven structure. The light diffusers 89 may instead each be configured with a microlens array diffuser plate having a regular uneven structure. The light diffusers 89 diffuse the blue light B output via the first end surface 73a of the light transmissive member 73. The light diffusers 89 in the present embodiment correspond to the light diffusing section in the claims. Note that the light diffusing section may instead be the first end surface 73a of the light transmissive member 73 that is directly so processed to have unevenness.

The other configurations of the light source apparatus 30D are the same as those of the light source apparatus 30A according to the first embodiment.

### Advantages of Fourth Embodiment

Also in the present embodiment, since the temporal change in the polarization state of the blue light B temporally changes the speckle pattern, the same advantages as those provided by the first embodiment can be provided, for example, the speckles can be sufficiently suppressed.

Since the blue light propagating through the light guides 71 and 72 is light as a result of parallelizing the light from LDs, which are point light sources, the blue light has a small divergence angle when output via the first end surface 73a of the light transmissive member 73 and show a light orientation distribution having a thin peak. On the other hand, the fluorescence Y output from the wavelength converter 51 has a large divergence angle and shows a Lambert light orientation distribution. The white light LW, which is the combination of the blue light B and the yellow fluorescence Y, may therefore cause color unevenness in a downstream optical system due to the difference in the light orientation distribution between the blue light and the yellow light. In contrast, in the light source apparatus 30D according to the present embodiment, since the light diffusers 89 are provided at the first end surface 73a of the light transmissive member 73, the blue light B exits out of the light source apparatus 30D in the state in which the blue light B is diffused by the light diffusers 89. The light orientation distribution of the blue light B can thus be made close to the light orientation distribution of the yellow fluorescence Y, so that the color unevenness in a downstream optical system can be reduced.

### Fifth Embodiment

A fifth embodiment of the present disclosure will be described below with reference to FIG. 10.

The present embodiment will be described with reference to another example of the projector including the light source apparatus 30A according to the first embodiment. Note, however, that the projector according to the present example may include any of the light source apparatuses 30B, 30C, and 30D according to the other embodiments.

FIG. 10 is a schematic configuration diagram of a projector 15 according to the present embodiment.

The projector 15 according to the present embodiment includes the light source apparatus 30A, a pickup lens 21, a rotary color wheel 22, a rod integrator 23, a light collecting lens 24, a reflection mirror 25, a digital micromirror device (DMD) 26, and a projection lens 27, as shown in FIG. 10. That is, the projector 15 according to the present embodiment is a projector including a DMD as a light modulator.

In the projector 15 according to the present embodiment, since the DMD 26 is used in place of a liquid crystal panel as the light modulator, the polarization converter described in the first embodiment is unnecessary. The advantage of suppressing speckles provided by the polarization converter changing the spatial distribution of the white light cannot be provided. Instead, since a speckle pattern produced by the P-polarized light, which does not interfere with the S-polarized light, and a speckle pattern produced by the S-polarized light, which does not interfere with the P-polarized light, are superimposed on the screen SCR, the speckles can be suppressed.

Note that the technical scope of the present disclosure is not limited to the embodiments described above, and various modifications can be made thereto to the extent that the modifications do not depart from the intent of the present disclosure.

For example, the embodiments described above have been presented with reference to the case where the first and second light emitting sections each include two light emitters, but the first and second light emitting sections may each include one light emitter.

In the embodiments described above, the first light source is disposed so as to face both the first and second side surfaces of the wavelength converter, and the excitation light enters the wavelength converter via both the first and second side surfaces. In place of the configuration described above, the first light source may be disposed so as to face only one of the first and second side surfaces of the wavelength converter, and the excitation light may enter the wavelength converter via the one side surface. In this case, a heat conducting member, for example, an enclosure may be brought into contact with the side surface on which the excitation light is not incident. The heat of the wavelength converter can thus be efficiently dissipated.

In addition, the specific description of the shapes, the numbers, the arrangements, the materials, and other factors of the elements of the light source apparatus and the projector are not limited to those in the embodiments described above, and can be changed as appropriate. The aforementioned embodiments have been described with reference to the case where any of the light source apparatuses according to the present disclosure is incorporated in a projector using liquid crystal panels, but is not limited thereto. The light source apparatuses according to the present disclosure may each be used in a projector using digital micromirror devices as the light modulators. The projector may not include multiple light modulators, and may include only one light modulator.

The aforementioned embodiments have been described with reference to the case where the light source apparatuses according to the present disclosure are each incorporated in a projector, but is not limited thereto. The light source apparatuses according to the present disclosure may each be incorporated in a lighting instrument, a headlight of an automobile, and other instruments.

### Summary of Present Disclosure

The present disclosure is summarized below as additional remarks.

### Additional Remark 1

A light source apparatus including:
a first light source configured to output first light having a first wavelength band;
a wavelength converter configured to convert the first light into second light having a second wavelength band different from the first wavelength band;
a second light source configured to output third light having a third wavelength band;
a light guide disposed between the first light source and the wavelength converter and configured to guide each of the first light, the second light, and the third light; and
a controller configured to control a state in which the second light source outputs the third light,
wherein the wavelength converter has a first surface and a second surface that face each other in opposite directions, and a third surface that intersects with the first surface and the second surface,
the first light output from the first light source enters the wavelength converter through the third surface via the light guide,
the second light travels through the light guide and exits out of a region on the first surface side of the light guide,
the third light includes fourth light in a first polarization state, and fifth light in a second polarization state different from the first polarization state, and enters a region on the second surface side of the light guide,
the second light source includes a first light emitting section configured to emit the fourth light and a second light emitting section configured to emit the fifth light,
the first light emitting section and the second light emitting section each include a laser diode, and
the controller is configured to temporally change a ratio between an amount of the fourth light emitted from the first light emitting section and an amount of the fifth light emitted from the second light emitting section.

According to the configuration of Additional Remark 1, since the polarization state of the third light temporally changes to temporally change the speckle pattern, speckles caused by the third light can be sufficiently suppressed.

### Additional Remark 2

The light source apparatus according to Additional Remark 1, wherein
the second light source further includes a light combiner configured to combine the fourth light emitted from the first light emitting section with the fifth light emitted from the second light emitting section.

The configuration of Additional Remark 2, in which the fourth light and the fifth light are combined with each other by the light combiner, allows the combined light, which is the combination of light having different polarization states, to efficiently enter the region of the light guide, which is a region facing the second surface.

### Additional Remark 3

The light source apparatus according to Additional Remark 1 or 2, wherein
the controller is configured to change the ratio between a first ratio set in a first period and a second ratio different from the first ratio and set in a second period with multiple periods including the first period and the second period cyclically and repeatedly switched from one to another, and
a frequency at which the multiple periods are repeatedly switched from one to another is 60 Hz or higher.

According to the configuration of Additional Remark 3, flicker of a projection image on a projection receiving surface can be suppressed.

### Additional Remark 4

The light source apparatus according to Additional Remark 3, wherein
a sum of an amount of the fourth light and an amount of the fifth light in the first period is equal to a sum of an amount of the fourth light and an amount of the fifth light in the second period.

According to the configuration of Additional Remark 4, since the amount of the third light does not change between the first period and the second period, the flicker of a projection image on the projection receiving surface can be further suppressed.

### Additional Remark 5

The light source apparatus according to any one of Additional Remarks 1 to 4, wherein
the fourth light has a first center wavelength,
the fifth light has a second center wavelength different from the first center wavelength, and
a difference between the first center wavelength and the second center wavelength is 2 nm or greater.

According to the configuration of Additional Remark 5, since the center wavelength of the third light changes by 2 nm or greater whenever the period changes, the speckle pattern changes over time, so that the speckles can be effectively suppressed.

### Additional Remark 6

The light source apparatus according to any one of Additional Remarks 1 to 5, wherein
the fourth light includes sixth light in the first polarization state and seventh light in the first polarization state,
the first light emitting section includes a first light emitter configured to emit the sixth light and a second light emitter configured to emit the seventh light,
the fifth light includes eighth light in the second polarization state and ninth light in the second polarization state, and
the second light emitting section includes a third light emitter configured to emit the eighth light and a fourth light emitter configured to emit the ninth light.

According to the configuration of Additional Remark 6, since the light emitting sections each include two light emitters, the amount of the third light can be increased.

### Additional Remark 7

The light source apparatus according to Additional Remark 6, wherein
the sixth light has a third center wavelength,
the seventh light has a fourth center wavelength different from the third center wavelength,
a difference between the third center wavelength and the fourth center wavelength is 2 nm or greater,
the eighth light has a fifth center wavelength,
the ninth light has a sixth center wavelength different from the fifth center wavelength, and
a difference between the fifth center wavelength and the sixth center wavelength is 2 nm or greater.

According to the configuration of Additional Remark 7, since the fourth light and the fifth light emitted from the light emitting sections each contain two types of light having center wavelengths separated by 2 nm or greater, the coherency of the two types of light in a single period decreases, so that the speckles can be effectively suppressed.

### Additional Remark 8

The light source apparatus according to any one of Additional Remarks 1 to 7, wherein
the light guide includes a light transmissive member configured to transmit the first light, the second light, and the third light, and
the second light and the third light exit from an end surface of the light transmissive member that is a surface facing the first surface.

According to the configuration of Additional Remark 8, combined light that is the combination of the second light and the third light can be extracted out of the light source apparatus via the light transmissive member, which constitutes the light guide. Furthermore, since heat of the wavelength converter is transferred to the light transmissive member, an increase in the temperature of the wavelength converter can be suppressed, so that a decrease in the wavelength conversion efficiency can be suppressed.

### Additional Remark 9

The light source apparatus according to any one of Additional Remarks 1 to 7, wherein
the light guide includes an air layer, and
the second light and the third light exit out of a region on the first surface side of the air layer.

According to the configuration of Additional Remark 9, combined light that is the combination of the second light and the third light can be extracted out of the light source apparatus via the air layer, which constitutes the light guide. Furthermore, since the region of the air layer, which is a region facing the first surface, is open to the external space, no refraction or reflection occurs at the end surface of the air layer, so that the efficiency at which the combined light is extracted can be increased.

### Additional Remark 10

The light source apparatus according to any one of Additional Remarks 1 to 9, wherein
the third surface of the wavelength converter has a first side surface and a second side surface that face each other in opposite directions,
the light guide includes a first light guide disposed so as to face the first side surface and a second light guide disposed so as to face the second side surface, and
the first light source includes a third light source configured to cause the first light to enter the wavelength converter via the first light guide, and a fourth light source configured to cause the first light to enter the wavelength converter via the second light guide.

According to the configuration of Additional Remark 10, the amount of the first light that enters the wavelength converter can be increased, so that the amount of the second light can be increased.

### Additional Remark 11

The light source apparatus according to any one of Additional Remarks 1 to 9, wherein
the wavelength converter includes a first wavelength converter configured to convert the first light and the second light into the third light and a second wavelength converter configured to convert the first light and the second light into the third light,
the light guide is disposed between the first wavelength converter and the second wavelength converter, and
the first light source includes a third light source configured to cause the first light to enter the first wavelength converter and a fourth light source configured to cause the first light to enter the second wavelength converter.

According to the configuration of Additional Remark 11, the amount of the first light that enters the wavelength converter can be increased, so that the amount of the second light can be increased.

### Additional Remark 12

The light source apparatus according to any one of Additional Remarks 1 to 11, wherein
the first light is blue light,
the second light is yellow light including a green light component and a red light component, and
the third light is blue light.

According to the configuration of Additional Remark 12, a light source apparatus capable of efficiently outputting white light can be realized.

### Additional Remark 13

The light source apparatus according to any one of Additional Remarks 1 to 12, further including
a light diffusing section disposed in a region on the first surface side of the light guide and configured to diffuse the third light.

According to the configuration of Additional Remark 13, the light orientation distribution of the third light can be widened to be close to the light orientation distribution of the second light, so that color unevenness in a downstream optical system can be reduced.

### Additional Remark 14

The light source apparatus according to any one of Additional Remarks 1 to 13, wherein
the first light source includes a light emitting diode configured to emit the first light.

According to the configuration of Additional Remark 14, the cost of the light source apparatus can be reduced, and the light emission efficiency of the light source apparatus can be improved.

### Additional Remark 15

An illuminator including:
the light source apparatus according to any one of Additional Remarks 1 to 14; and
a polarization converter configured to convert a polarization state of light output from the light source apparatus.

According to the configuration of Additional Remark 15, since the position where the third light from the polarization converter exits changes in correspondence with each of the first period and the second period, the spatial distribution of the third light in an optical system downstream from the polarization converter temporally changes. Accordingly, since the speckle pattern changes over time, the speckles can be more effectively suppressed.

### Additional Remark 16

A projector including:
the light source apparatus according to any one of Additional Remarks 1 to 14;
a light modulator configured to modulate light output from the light source apparatus; and
a projection optical apparatus configured to project the light modulated by the light modulator.

According to the configuration of Additional Remark 16, since the light source apparatus outputs combined light that is the combination of the second light and the third light, only one light source apparatus suffices, so that a projector having a highly efficient and simple configuration and excellent display quality can be realized.

What is claimed is:

1. A light source apparatus comprising:
a first light source configured to output first light having a first wavelength band;
a wavelength converter configured to convert the first light into second light having a second wavelength band different from the first wavelength band;
a second light source configured to output third light having a third wavelength band;
a light guide disposed between the first light source and the wavelength converter and configured to guide each of the first light, the second light, and the third light; and
a controller configured to control a state in which the second light source outputs the third light,
wherein the wavelength converter has a first surface and a second surface that face each other in opposite directions, and a third surface that intersects with the first surface and the second surface,
the first light output from the first light source enters the wavelength converter through the third surface via the light guide,
the second light travels through the light guide and exits out of a region on the first surface side of the light guide,
the third light includes fourth light in a first polarization state, and fifth light in a second polarization state different from the first polarization state, and enters a region on the second surface side of the light guide,
the second light source includes a first light emitting section configured to emit the fourth light and a second light emitting section configured to emit the fifth light,
the first light emitting section and the second light emitting section each include a laser diode, and
the controller is configured to temporally change a ratio between an amount of the fourth light emitted from the first light emitting section and an amount of the fifth light emitted from the second light emitting section.

2. The light source apparatus according to claim 1, wherein
the second light source further includes a light combiner configured to combine the fourth light emitted from the first light emitting section with the fifth light emitted from the second light emitting section.

3. The light source apparatus according to claim 1, wherein
the controller is configured to change the ratio between a first ratio set in a first period and a second ratio different from the first ratio and set in a second period with multiple periods including the first period and the second period cyclically and repeatedly switched from one to another, and
a frequency at which the multiple periods are repeatedly switched from one to another is 60 Hz or higher.

4. The light source apparatus according to claim 3, wherein
a sum of an amount of the fourth light and an amount of the fifth light in the first period is equal to a sum of an amount of the fourth light and an amount of the fifth light in the second period.

5. The light source apparatus according to claim 1, wherein
the fourth light has a first center wavelength,
the fifth light has a second center wavelength different from the first center wavelength, and
a difference between the first center wavelength and the second center wavelength is 2 nm or greater.

6. The light source apparatus according to claim 1, wherein
the fourth light includes sixth light in the first polarization state and seventh light in the first polarization state,
the first light emitting section includes a first light emitter configured to emit the sixth light and a second light emitter configured to emit the seventh light,
the fifth light includes eighth light in the second polarization state and ninth light in the second polarization state, and
the second light emitting section includes a third light emitter configured to emit the eighth light and a fourth light emitter configured to emit the ninth light.

7. The light source apparatus according to claim 6, wherein
the sixth light has a third center wavelength,
the seventh light has a fourth center wavelength different from the third center wavelength,
a difference between the third center wavelength and the fourth center wavelength is 2 nm or greater,
the eighth light has a fifth center wavelength,
the ninth light has a sixth center wavelength different from the fifth center wavelength, and
a difference between the fifth center wavelength and the sixth center wavelength is 2 nm or greater.

8. The light source apparatus according to claim 1, wherein
the light guide includes a light transmissive member configured to transmit the first light, the second light, and the third light, and
the second light and the third light exit from an end surface of the light transmissive member that is a surface facing the first surface.

9. The light source apparatus according to claim 1, wherein
the light guide includes an air layer, and
the second light and the third light exit out of a region on the first surface side of the air layer.

10. The light source apparatus according to claim 1, wherein
the third surface of the wavelength converter has a first side surface and a second side surface that face each other in opposite directions,
the light guide includes a first light guide disposed so as to face the first side surface and a second light guide disposed so as to face the second side surface, and
the first light source includes a third light source configured to cause the first light to enter the wavelength converter via the first light guide, and a fourth light source configured to cause the first light to enter the wavelength converter via the second light guide.

11. The light source apparatus according to claim 1, wherein
the wavelength converter includes a first wavelength converter configured to convert the first light and the second light into the third light and a second wavelength converter configured to convert the first light and the second light into the third light,
the light guide is disposed between the first wavelength converter and the second wavelength converter, and
the first light source includes a third light source configured to cause the first light to enter the first wavelength converter and a fourth light source configured to cause the first light to enter the second wavelength converter.

12. The light source apparatus according to claim 1, wherein
the first light is blue light,
the second light is yellow light including a green light component and a red light component, and
the third light is blue light.

13. The light source apparatus according to claim 1, further comprising
a light diffusing section disposed in a region on the first surface side of the light guide and configured to diffuse the third light.

14. The light source apparatus according to claim 1, wherein
the first light source includes a light emitting diode configured to emit the first light.

15. An illuminator comprising:
the light source apparatus according to claim 1; and
a polarization converter configured to convert a polarization state of light output from the light source apparatus.

16. A projector comprising:
the light source apparatus according to claim 1;
a light modulator configured to modulate light output from the light source apparatus; and
a projection optical apparatus configured to project the light modulated by the light modulator.
